(19) United States
(12) Patent Application Publication
(10) Pub. No.: US 2025/0123420 A1
(43) Pub. Date: Apr. 17, 2025

(54) GAS ADVANCED DEVELOPMENT (GAD) WORKFLOW

(71) Applicant: SAUDI ARABIAN OIL COMPANY, Dhahran (SA)

(72) Inventors: Maytham I. Al Ismail, Al Jish (SA); Mohammed A. Islam, Dhahran (SA); Naif K. Al-Shihab, Dammam (SA); Hammam Aloweiny, Jeddah (SA)

(73) Assignee: SAUDI ARABIAN OIL COMPANY, Dhahran (SA)

(21) Appl. No.: 18/485,918

(22) Filed: Oct. 12, 2023

(51) Int. Cl. E21B 41/00; E21B 7/04; E21B 33/03; E21B 43/26; E21B 44/00; E21B 47/06; E21B 49/00; G01V 99/00

(52) U.S. Cl. CPC G01V 20/00; E21B 7/046; E21B 43/26; E21B 44/00; E21B 49/005; G01V 1/00; G01V 2210/66

(57) ABSTRACT

Method for identifying and developing a gas advanced horizontal well. The method includes obtaining a subsurface model for a subterranean region of interest encompassing a Khuff formation. The method further includes identifying the gas advanced horizontal well by determining a well location that meets a reservoir criterion based on the subsurface model and determining a planned wellbore path that meets a horizontal well directional plan criterion based on the subsurface model and an initial completions assessment. The method further includes determining a set of petrophysical logging tools based on the subsurface model and planned wellbore path, drilling the gas advanced horizontal well according to the planned wellbore path, and obtaining a petrophysical log across a reservoir section using the set of petrophysical logging tools. The method further includes completing the gas advanced horizontal well based on a position of the gas advanced horizontal well relative to the Khuff formation.

### BACKGROUND

Oil and gas extraction from subsurface rock formations requires the drilling of wells using drilling rigs mounted on the ground or on offshore rig platforms. Once drilled and completed, the wells may access hydrocarbon reservoirs. As such, the process of developing oil and gas fields encompasses many activities, such as, drilling, completions, and production (i.e., operation of at least one well).

In simplest terms, an optimally managed oil and gas field is one that minimizes drilling and completions costs while maximizing hydrocarbon production. In contrast, drilling, completing, and operating wells without proper and guiding criteria can result in inefficient oil and gas field development with sub-optimal production and high development costs. As a further cost-incurring consequence, additional wells may need to be drilled in order to meet desired production rates. Accordingly, there exists a need for determining well selection and development processes to maximize production while minimizing the required number of wells in an oil and gas field.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for identifying and developing a gas advanced horizontal well. The method includes obtaining a subsurface model for a subterranean region of interest encompassing, at least partially, a Khuff formation. The method further includes identifying the gas advanced horizontal well by determining a well location that meets a reservoir criterion based on the subsurface model and determining a planned wellbore path that meets a horizontal well directional plan criterion based on the subsurface model and an initial completions assessment. The method further includes determining a set of petrophysical logging tools based on the subsurface model and planned wellbore path, drilling the gas advanced horizontal well according to the planned wellbore path, and obtaining a petrophysical log across a reservoir section using the set of petrophysical logging tools. The method further includes completing the gas advanced horizontal well based on a position of the gas advanced horizontal well relative to the Khuff formation.

Embodiments disclosed herein generally relate to a system for, at least, identifying and developing a gas advanced horizontal well. The system includes a drilling operations system configured to drill a wellbore through a subterranean region of interest encompassing, at least partially, a Khuff formation. The system further includes a computer, the computer configured to obtain a subsurface model for the subterranean region of interest. The computer is further configured to identify a gas advanced horizontal well by determining a well location that meets a reservoir criterion based on the subsurface model and determining a planned wellbore path that meets a horizontal well directional plan criterion based on the subsurface model and an initial completions assessment. The computer is further configured to determine a set of petrophysical logging tools based on the subsurface model and planned wellbore path, transmit a command signal to the drilling operations system to drill the gas advanced horizontal well according to the planned wellbore path, and obtain a petrophysical log across a reservoir section using the set of petrophysical logging tools. The computer is further configured to determine a completions plan for the gas advanced horizontal well based on a position of the gas advanced horizontal well relative to the Khuff formation.

Embodiments disclosed herein generally relate to a non-transitory computer-readable medium including computer-executable instructions stored thereon that, when executed on a processor, cause the processor to perform the following steps. The steps include obtaining a subsurface model for a subterranean region of interest encompassing, at least partially, a Khuff formation. The steps further include identifying a gas advanced horizontal well by determining a well location that meets a reservoir criterion based on the subsurface model and determining a planned wellbore path that meets a horizontal well directional plan criterion based on the subsurface model and an initial completions assessment. The steps further include determining a set of petrophysical logging tools based on the subsurface model and planned wellbore path, determining a completions plan for the gas advanced horizontal well based on a position of the gas advanced horizontal well relative to the Khuff formation, and transmitting a command signal to a drilling system to drill the gas advanced horizontal well according to the planned wellbore path.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example well site in accordance with one or more embodiments.

FIG. 2 depicts a reservoir grid model in accordance with one or more embodiments.

FIG. 3 depicts a system in accordance with one or more embodiments.

FIG. 4 depicts a flowchart in accordance with one or more embodiments.

FIG. 5A depicts a dip angle in accordance with one or more embodiments.

FIG. 5B depicts an example allowable lateral deviation in view of a horizontal plane in accordance with one or more embodiments.

FIG. 6 depicts an example porosity heat map in accordance with one or more embodiments.

FIG. 7 depicts a flowchart in accordance with one or more embodiments.

FIG. 8 depicts a flowchart in accordance with one or more embodiments.

FIG. 9 depicts a flowchart in accordance with one or more embodiments.

FIG. 10 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “subsurface model” may include any number of “subsurface models” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

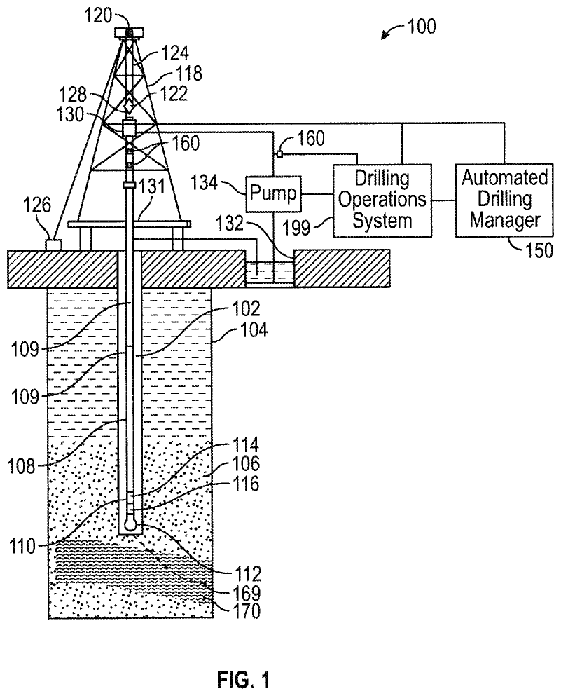

In the following description of FIGS. 1-10, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein relate to a gas advanced horizontal well development system that determines an identification and development workflow for long, or extended, horizontal gas wells in subterranean regions of interest that contain, at least partially, the Khuff formation.

Long horizontal gas wells with multistage stimulation completion can potentially reduce costs associated with gas production. This is because, in theory, the extended reach of these wells is able to access distant reservoirs while reducing the total infrastructure and operational footprint that would otherwise be required to access the reservoir through development of another well located closer to the reservoir. This benefit is increased when considering that it may not be possible to develop another well with greater proximity to the distant reservoir and in view of the additional infrastructure needed to transport and process the retrieved hydrocarbons. However, if not developed properly, long horizontal gas wells can incur costs disproportionate to their alleged increased production opportunity. For example, increased lateral length is useless if the added portion is not productive.

The Khuff formation is a late-Permian-age heterogeneous sequence composed of thick evaporitic carbonates and intercalated anhydrites. The Khuff formation defines a platform that extends into multiple countries of the Arabian Gulf including Saudi Arabia, Bahrain, Qatar, and Iran. Several large reservoirs are known to exist in the Khuff formation. However, the heterogeneous and cyclic structure of carbonate-evaporite deposits forming the Khuff make efficiently extracting hydrocarbon resources (specifically, gas) from these reservoirs a complex process.

As will be described herein and in accordance with one or more embodiments, the gas advanced horizontal well system provides processes, methods, models, criteria, and a Khuff-specific workflow for identifying the placement of long horizontal gas wells and managing their development such that these wells efficiently produce gaseous hydrocarbons. In one or more embodiments, the gas advanced horizontal well system defines best practices, including specifying the drilling operation, development activities, and completions tools and/or equipment, to be employed when drilling and developing a long horizontal gas well in the Khuff formation. These best practices, tools, processes, criteria, etc. are tailored to the subsurface geology. Hereafter, candidate wells identified and subsequently developed to form long horizontal gas wells as determined by the gas advanced horizontal well development system described herein are referred to as gas advanced horizontal wells. As such, in one or more embodiments, it may be said that the gas advanced horizontal well development system is used to produce gas advanced horizontal wells.

FIG. 1 illustrates an example well site (100). A well site (100) may be used to extract oil and gas, generally referred to as hydrocarbons, from underground reservoirs such as those associated with the Khuff formation. In general, well sites may be configured in a myriad of ways. Therefore, well site (100) is not intended to be limiting with respect to the particular configuration of the drilling equipment. The well site (100) is depicted as being on land. In other examples, the well site (100) may be offshore, and drilling may be carried out with or without use of a marine riser. A drilling operation at well site (100) may include drilling a wellbore (102) into a subsurface including various formations (104, 106). For the purpose of drilling a new section of wellbore (102), a drill string (108) is suspended within the wellbore (102).

The drill string (108) may include one or more drill pipes (109) connected to form conduit and a bottom hole assembly (BHA) (110) disposed at the distal end of the conduit. The BHA (110) may include a drill bit (112) to cut into the subsurface rock. The BHA (110) may include measurement tools (114), such as a measurement-while-drilling (MWD) tool and logging-while-drilling (LWD) tool. Measurement tools (114) may include sensors and hardware to measure downhole drilling parameters, and these measurements may be transmitted to the surface using any suitable telemetry system known in the art. The BHA (110) and the drill string (108) may include other drilling tools known in the art but not specifically shown.

The drill string (108) may be suspended in wellbore (102) by a derrick (118). A crown block (120) may be mounted at the top of the derrick (118), and a traveling block (122) may hang down from the crown block (120) by means of a cable or drilling line (124). One end of the cable (124) may be connected to a drawworks (126), which is a reeling device that may be used to adjust the length of the cable (124) so that the traveling block (122) may move up or down the derrick (118). The traveling block (122) may include a hook (128) on which a top drive (130) is supported.

The top drive (130) is coupled to the top of the drill string (108) and is operable to rotate the drill string (108). Alternatively, the drill string (108) may be rotated by means of a rotary table (not shown) on the drilling floor (131). Drilling fluid (commonly called “mud”) may be stored in a mud pit (132), and at least one pump (134) may pump the mud from the mud pit (132) into the drill string (108). The mud may flow into the drill string (108) through appropriate flow paths in the top drive (130) (or a rotary swivel if a rotary table is used instead of a top drive to rotate the drill string (108)). Drilling fluid (or mud) is any fluid that is circulated in the wellbore (102) to aid in the drilling operation. Drilling fluids may be broadly categorized according to their principal constituent. For example, a drilling fluid may be said to be an oil-based mud (OBM), water-based mud (WBM), brine-based fluid, or synthetic-based fluid. The base component for a water-based drilling fluid (or WBM) may be fresh water, seawater, brine, saturated brine, or a formate brine. The liquid part of a drilling fluid is known as “mud filtrate.” When a drilling fluid passes through a porous medium (e.g., subsurface formation (104, 106)), solid particulates suspended in the drilling fluid may become separated from the mud filtrate. Solid particulates, upon separation, may accumulate and form a layer commonly known as “mudcake.” Some well sites (100) may include a drilling fluid processing system (not shown in FIG. 1). The drilling fluid processing system may include hardware and/or software with functionality for automatically supplying and/or mixing weighting agents, buffering agents, rheological modifiers, and/or other additives to the drilling fluid until it matches and/or satisfies one or more desired drilling fluid properties. In other words, the composition of a drilling fluid may be complex and a drilling fluid may be tailored to a specific well site (100), and, in some instances, the composition of a drilling fluid may be altered in real-time according to the needs of a drilling operation.

In some implementations, a drilling operations system (199) may be disposed at or communicate with the well site (100). Drilling operations system (199) may control at least a portion of a drilling operation at the well site (100) by providing controls to various components of the drilling operation. In one or more embodiments, drilling operations system (199) may receive data from one or more sensors (160) arranged to measure controllable parameters of the drilling operation. As a non-limiting example, sensors (160) may be arranged to measure: weight on bit (WOB), drill string rotational speed (e.g., rotations per minute (RPM)), flow rate of the mud pumps (e.g., in the units of gallons per minute (GPM)), and rate of penetration of the drilling operation (ROP). In one or more embodiments, the drilling operation may be controlled by the drilling operations system (199).

Sensors (160) may be positioned to measure parameter(s) related to the rotation of the drill string (108), parameter(s) related to travel of the traveling block (122), which may be used to determine ROP of the drilling operation, and parameter(s) related to flow rate of the pump (134). For illustration purposes, sensors (160) are shown on drill string (108) and proximate mud pump (134). The illustrated locations of sensors (160) are not intended to be limiting, and sensors (160) could be disposed wherever drilling parameters need to be measured. Moreover, there may be many more sensors (160) than shown in FIG. 1 to measure various other parameters of the drilling operation. Each sensor (160) may be configured to measure a desired physical stimulus.

During a drilling operation at the well site (100), the drill string (108) is rotated relative to the wellbore (102), and weight is applied to the drill bit (112) to enable the drill bit (112) to break rock as the drill string (108) is rotated. In some cases, the drill bit (112) may be rotated independently with a drilling motor. In some implementations, the drilling motor is a positive displacement motor (116) located on the distal end of the drill string (108) as part of the BHA (110). In further embodiments, the drill bit (112) may be rotated using a combination of the drilling motor, such as a positive displacement motor (116), and the top drive (130) (or a rotary swivel if a rotary table is used instead of a top drive to rotate the drill string (108)). While cutting rock with the drill bit (112), mud is pumped into the drill string (108).

The drilling fluid flows down the drill string (108) and exits into the bottom of the wellbore (102) through nozzles in the drill bit (112). The drilling fluid in the wellbore (102) then flows back up to the surface in an annular space between the drill string (108) and the wellbore (102) with entrained cuttings.

The drilling fluid with the cuttings is returned to the pit (132) to be circulated back again into the drill string (108). Typically, the cuttings are removed from the drilling, and the drilling fluid is reconditioned as necessary, before pumping the drilling fluid again into the drill string (108).

In one or more embodiments, the separation of the cuttings from the drilling fluid may be performed by means of a shale shaker (not shown). In some cases, the cuttings that are separated from the returning drilling fluid may be collected. The removed cuttings can be located at any distance from the drilling site.

At the surface, the returning drilling fluid may also contain dissolved gases that were collected from the wellbore (102). Examples of such gases include carbon dioxide, methane, and hydrogen sulfide. Gases may be separated from the returning drilling fluid using a gas-mud separator system. The separation of the gases from the drilling fluid may occur before, after, or at the same time as the separation of the cuttings from the drilling fluids. In one or more embodiments, the cuttings and a mixture of gases (i.e., a gas mixture) collected from the returned drilling fluid are evaluated to determine properties and characteristics of the subsurface formations (104, 106) during drilling. For example, evaluation the gas mixture may include determining the relative overall quantity (e.g., mass and/or volume) of the gas mixture with respect to the returned drilling fluid and determining the quantity, or concentration, of at least one gas in the gas mixture. Likewise, evaluation of the cuttings may include classifying a rock type (e.g., limestone, dolomite, etc.) to the cuttings, determining a distribution of rock types for the cuttings (e.g., based on percent volume of rock type), or otherwise determining the lithology of the cuttings. The process and methods associated with determining subsurface characteristics from returned drilling fluid is known as mudlogging. As such, data acquired using mudlogging processes and methods may be referred to as mudlogging data.

Depending on the depth of hydrocarbon bearing formation and other geological complexes, a well can have several hole sizes before it reaches its target depth. A steel pipe, or casing (not shown), may be lowered in each hole and a cement slurry may be pumped from the bottom up through the presumably annular space between the casing and the wellbore (102) to fix the casing, seal the wellbore from the surrounding subsurface (104, 106) formations, and ensure proper well integrity throughout the lifecycle of the well. The casing may be inserted periodically while drilling out the well.

Upon finishing drilling the wellbore (102), the well may undergo a “completions” process to stabilize the well and provide reliable access to the desired hydrocarbons. In some implementations, the final wellbore (102) can be completed using either cased and cemented pipe, which is later perforated to access the hydrocarbon, or it may be completed using open-hole multistage fracturing. Once completed, a well site (100) may be used in production to extract hydrocarbons from underground reservoirs.

As shown in FIG. 1, the wellbore (102) may be drilled according to a wellbore path (169). The wellbore path (169), and thus the wellbore (102) upon drilling, may traverse and/or intersect a target zone (170), or “pay zone,” that may include a hydrocarbon reservoir within the subsurface. In general, the wellbore path (169) may be a curved wellbore path, or a straight wellbore path. All or part of the wellbore path (169) may be vertical, and some wellbore paths may be deviated or have horizontal sections. In particular, for a gas advanced horizontal well as described herein, a horizontal section of the well may extend for a long length (e.g., exceeding 1 mile).

Prior to the commencement of drilling, a wellbore plan may be generated. The wellbore plan may include a starting surface location of the wellbore, or a subsurface location within an existing wellbore, from which the wellbore may be drilled. Further, the wellbore plan may include a terminal location that may intersect with the target zone (170), e.g., a targeted hydrocarbon-bearing formation, and a planned wellbore path (169) from the starting location to the terminal location. In other words, the wellbore path (169) may intersect a previously located hydrocarbon reservoir.

Typically, the wellbore plan is generated based on best available information at the time of planning from, but not limited to: a geophysical model; geomechanical models encapsulating subterranean stress conditions; the trajectory of any existing wellbores (which it may be desirable to avoid); petrophysical data; and the existence of other drilling hazards, such as shallow gas pockets, over-pressure zones, and active fault planes. In accordance with one or more embodiments, the wellbore plan for a gas advanced horizontal well is informed by knowledge of the Khuff formation and determined, at least in part, by the gas advanced horizontal well development system described in greater detail later in the instant disclosure.

The wellbore plan may include wellbore geometry information such as wellbore diameter and inclination angle. If casing (not shown in FIG. 1) is used, the wellbore plan may include casing type or casing depths. Furthermore, the wellbore plan may consider other engineering constraints such as the maximum wellbore curvature (“dog-log”) that the drillstring (108) may tolerate and the maximum torque and drag values that the drilling system (100) may tolerate. As will be shown, the gas advanced horizontal well development system specifies development processes tailored to the subsurface.

An automated drilling manager (150) may be used to generate the wellbore plan. The automated drilling manager (150) may include one or more computer processors in communication with computer memory containing any geophysical models, geomechanical models, knowledge of reservoir complexity and subsurface compartmentalization, and information relating to drilling hazards, and the constraints imposed by the limitations of the drillstring (108) and the drilling system (100) as well as any constraints and/or procedures mandated by the gas advanced horizontal well development system. The automated drilling manger (150) may further include dedicated software to determine the planned wellbore path (169) and associated drilling parameters, such as the planned wellbore diameter, the location of planned changes of the wellbore diameter, the planned depths at which casing will be inserted to support the wellbore (102) and to prevent formation fluids entering the wellbore, and the drilling mud weights (densities) and types that may be used during drilling the wellbore.

Finally, it is noted that to start drilling, or “spudding in” a new well, the hoisting system lowers the drillstring (108) suspended from the derrick (118) towards the planned surface location of the wellbore (102). An engine, such as a diesel engine, may be used to supply power to the top drive (130) to rotate the drillstring (108). The weight of the drillstring (108) combined with the rotational motion enables the drill bit (112) to bore the wellbore (102).

In many situations, the near-surface is typically made up of loose or soft sediment or rock, so large diameter casing, e.g., “base pipe” or “conductor casing,” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface of the earth.

Drilling may continue without any casing once deeper, or more compact rock is reached. While drilling, a drilling mud system may pump drilling mud from a mud tank (or the mud pit (132)) on the surface through the drill pipe (109). Drilling mud serves various purposes, including pressure equalization, removal of rock cuttings, and drill bit cooling and lubrication.

At planned depth intervals, drilling may be paused and the drillstring (108) withdrawn from the wellbore. Sections of casing may be connected and inserted and cemented into the wellbore. Casing string may be cemented in place by pumping cement and mud, separated by a “cementing plug,” from the surface through the drill pipe. The cementing plug and drilling mud force the cement through the drill pipe and into the annular space between the casing and the wellbore wall. Once the cement cures, drilling may recommence. The drilling process is often performed in several stages. Therefore, the drilling and casing cycle may be repeated more than once, depending on the depth of the wellbore and the pressure on the wellbore walls from surrounding rock.

Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

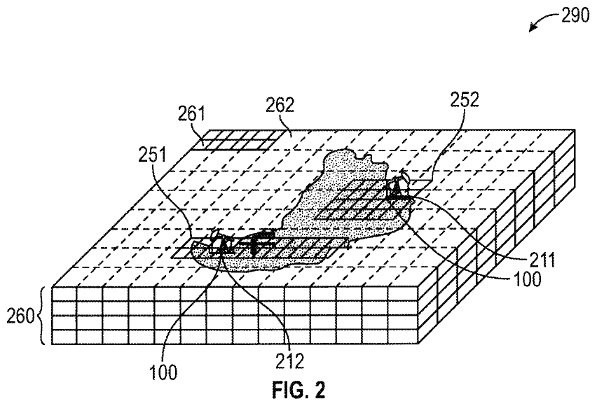

In accordance with one or more embodiments, and as described later in the instant disclosure, the gas advanced horizontal well development system may be used to inform, or in conjunction with, a reservoir simulator. Turning to FIG. 2, FIG. 2 shows the basis of a reservoir simulator in accordance with one or more embodiments. FIG. 2 shows a reservoir grid model (290) that corresponds to a geological region. The geological region may span multiple well sites (100) and a subsurface region of interest. The well sites (100) may include injection wells (212), which inject a fluid into the local subsurface formations (104, 106), or an extraction well (211). More specifically, the reservoir grid model (290) includes grid cells (261) that may refer to an original cell of a reservoir grid model as well as coarse grid blocks (262) that may refer to an amalgamation of original cells of the reservoir grid model. For example, a grid cell may be the case of a 1×1 block, where coarse grid blocks may be of sizes 2×2, 4×4, 8×8, etc. Both the grid cells (261) and the coarse grid blocks (262) may correspond to columns for multiple model layers (260) within the reservoir grid model (290).

Prior to performing a reservoir simulation, local grid refinement and coarsening (LGR) may be used to increase or decrease grid resolution in a certain area of reservoir grid model (290). For example, various reservoir properties, e.g., permeability, porosity or saturations, may correspond to a discrete value that is associated with a particular grid cell or coarse grid block. However, by using discrete values to represent a portion of a geological region, a discretization error may occur in a reservoir simulation. Thus, finer grids may reduce discretization errors as the numerical approximation of a finer grid is closer to the exact solution, however through a higher computational cost. As shown in FIG. 2, for example, the reservoir grid model (290) may include various fine-grid models (i.e., fine-grid model A (251), fine-grid model B (252)), that are surrounded by coarse block regions. Likewise, the original reservoir grid model (290) without any coarsening may also be a fine-grid model. In some embodiments, a reservoir grid model (or multiple reservoir grid models) may be used to preform reservoir simulations.

Generally, reservoir simulators solve a set of mathematical governing equations that represent the physical laws that govern fluid flow in porous, permeable media. For example, the flow of a single-phase slightly compressible oil with a constant viscosity and compressibility, equations that capture Darcy's law, the continuity condition, and the equation of state and may be written as:

$${∇}^{2} ρ ( x , t ) = \frac{ψμ {c}_{t}}{k} \frac{\partial p ( x , t )}{\partial t} , \qquad ( 1 )$$

where ρ represents fluid in the reservoir, x is a vector representing spatial position and t represents time. ψ, μ, cₜ, and k represent the physical and petrophysical properties of porosity, fluid viscosity, total combined rock and fluid compressibility, and permeability, respectively. ∇² represents the spatial Laplace operator.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks (as depicted in FIG. 2). The governing equations must then be solved by one of a variety of numerical methods, such as, without limitation, explicit or implicit finite-difference methods, explicit or implicit finite element methods, or discrete Galerkin methods.

In some embodiments, a reservoir simulator includes functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator may be used to predict changes in fluid flow, including fluid flow into well penetrating the reservoir as a result of planned well drilling, and fluid injection and extraction. For example, the reservoir simulator may be used to predict changes in hydrocarbon production rate that would result from the injection of water into the reservoir from wells around the reservoirs periphery.

A reservoir simulator may account for, among other things, the porosity and hydrocarbon storage capacity of the subsurface formations (104, 106) and target zone (170), and fluid transport pathways to predict the production rate of hydrocarbons of a well, or a set of wells, over their lifetime.

In accordance with one or more embodiments, the gas advanced horizontal well development system, along with a reservoir simulator, may make use of a subsurface model. Generally, a subsurface model contains a digital description of the physical properties of the rocks as a function of position within the subsurface region of interest and the fluids within the pores of the porous, permeable reservoir rocks at a given time. In some embodiments, the digital description may be in the form of a dense three-dimensional (3D) grid with the physical properties of the rocks and fluids defined at each node. In some embodiments, the 3D grid may be a cartesian grid, while in other embodiments the grid may be an irregular grid. For example, subsurface models may indicate the porosity and permeability throughout a subsurface volume in a region of interest (e.g., near or encompassing a reservoir and/or wellbore). Hereafter, to promote generality, the term “subsurface model” will be adopted to refer to the digital representation of one or more subsurface properties (e.g., petrophysical, thermodynamic, etc.) for a subsurface region of interest, where no restriction is placed on the grid format (e.g., 3D, regular, cartesian). Thus, the term “subsurface model” may encompass any number of subsurface property or characteristic models such as a subsurface porosity model and a subsurface lithology model.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected such as well logs (from measurement tools (114, 116)) and production data acquired in wells penetrating the reservoir may be used to determine physical and petrophysical properties along the segment of the well trajectory traversing the reservoir. For example, porosity, permeability, density, seismic velocity, and resistivity may be measured along these segments of wellbore. Data collected from previously drilled, nearby wells, sometimes called “offset” wells, may also be appended to the collected data. Moreover, so-called “soft” data, such as outcrop information and data describing analogous modern geological or depositional environments may be integrated with the acquired well site (100) data and seismic data to further refine the modeled subsurface formations (104, 106). In accordance with some embodiments, remote sensing geophysical surveys and physical and petrophysical properties determined from well logs may be combined to estimate physical and petrophysical properties for the entire reservoir grid model (290).

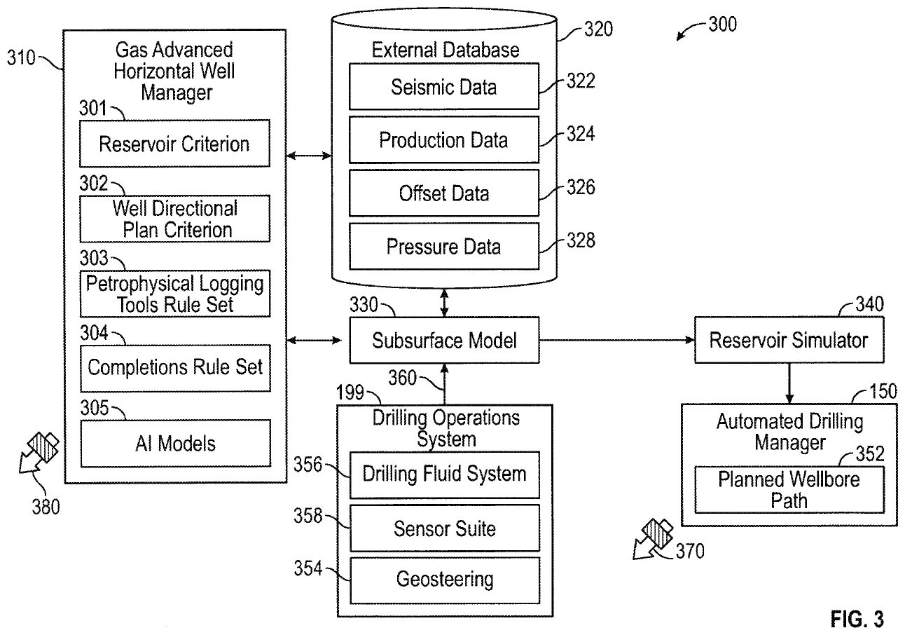

FIG. 3 depicts the gas advanced horizontal well development system (300), in accordance with one or more embodiments. FIG. 3 depicts, as a block diagram, various components, modules, and/or subsystems, where the components, modules, and/or subsystems may interact with each other. For example, in FIG. 3, a gas advanced horizontal well manager (310) is shown to interact with an external database (320), a subsurface model (330), etc. One with ordinary skill in the art will recognize that the partitioning, organization, and interaction of the components, modules, and/or subsystems of the gas advanced horizontal well development system (300), alongside interactions within said components, modules, and/or subsystems, in FIG. 3, is intended to promote clear discussion and should not be considered fixed or limiting. For example, FIG. 3 depicts the subsurface model (330) as an independent entity, however, in some embodiments, the subsurface model (330) may be encompassed by gas advanced horizontal well manager (310) and/or stored in the external database (320).

In accordance with one or more embodiments, the gas advanced horizontal well development system (300) includes an external database (320). The external database (320) stores digital media, such as data descriptive of one or more material properties and/or processes, associated with a subterranean region of interest where a gas advanced horizontal well may be developed. In one or more embodiments, the external database (320) stores seismic data (322) acquired from a seismic survey conducted over the subterranean region of interest. In one or more embodiments, the external database (320) further includes production data (324) representative of the quantity of hydrocarbons and other material phases (e.g., water) produced from existing wells proximate the location of a potential gas advanced horizontal well. In one or more embodiments, the external database further includes offset data (326) (e.g., LWD logs), again, from existing wells proximate the location of a potential gas advanced horizontal well. In one or more embodiments, the external database (320) further includes pressure data (328) associated with one or more reservoirs within the subterranean region of interest that may be penetrated and traversed by a potential gas advanced horizontal well. The pressure data (328) may include an estimate of pore pressures distributed over the one or more reservoirs.

In accordance with one or more embodiments, the gas advanced horizontal well development system (300) includes a subsurface model (330) of the subterranean region of interest (or, more simply, the subsurface) where a gas advanced horizontal well may be developed. As previously described, a subsurface model (330) is a digital representation of one or more subsurface properties (e.g., petrophysical, thermodynamic, etc.) such as porosity and geomechanical stress. The subsurface model (330) may be constructed using data stored in the external database (320) and updated and/or refined using data acquired while drilling (e.g., LWD logs).

In accordance with one or more embodiments, the gas advanced horizontal well development system (300) includes a reservoir simulator (340). In one or more embodiments, the reservoir simulator (340) is used to determine hydraulic fracturing originating from a lateral section of the wellbore. The reservoir simulator (340) may use the subsurface model (330) (e.g., a geomechanical stress model) to determine likely hydrocarbon transport pathways and mechanisms as well as a rate of production of hydrocarbons of a gas advanced horizontal well.

In accordance with one or more embodiments, the gas advanced horizontal well development system (300) includes an automated drilling manager (150). As previously described, the automated drilling manager (150) may be used to generate a planned wellbore path (352) for a gas advanced horizontal well. In one or more embodiments, the automated drilling manager (150) is in communication with the reservoir simulator (340) and/or the subsurface model (330). The automated drilling manager (150) may control aspects of a drilling operations system (199) (e.g., guiding the drill bit along the planned wellbore path (352)). In one or more embodiments, the automated drilling manager (150) transmits one or more control signals (e.g., command X (370)) to the drilling operations system (199) to control aspects of the drilling process (e.g., direction of the drill bit).

In accordance with one or more embodiments, the gas advanced horizontal well development system (300) includes a drilling operations system (199) like that described in reference to FIG. 1. As previously described, the automated drilling manager (150) may be used to generate a planned wellbore path (352) for a gas advanced horizontal well. In one or more embodiments, the automated drilling manager (150) is in communication with the reservoir simulator (340) and/or the subsurface model (330). The automated drilling manager (150) may control aspects of a drilling operations system (199) (e.g., guiding the drill bit along the planned wellbore path (352)).

In accordance with one or more embodiments, the gas advanced horizontal well development system includes a drilling operations system (199). The drilling operations system (199) may control at least a portion of a drilling operation at a well site (100) when drilling a gas advanced horizontal well such as providing controls to various components of the drilling operation. In one or more embodiments, drilling operations system (199) may receive data from one or more sensors (160) arranged to measure controllable parameters of the drilling operation. As such, the drilling operations system (199) may be said to include a sensor suite (358). One or more sensors in the sensor suite (354) may be arranged to measure: weight on bit (WOB), drill string rotational speed (e.g., rotations per minute (RPM)), flow rate of the mud pumps (e.g., in the units of gallons per minute (GPM)), and rate of penetration of the drilling operation (ROP). Sensor data (360) may be acquired using the sensor suite (358) and transmitted for use by the subsurface model (330). That is, the subsurface model (330) can be updated using sensor data (360) (e.g., LWD logs).

In one or more embodiments, the drilling operations system (199) further includes a drilling fluid system (356). The drilling fluid system (356) may include hardware and/or software with functionality for automatically supplying and/or mixing weighting agents, buffering agents, rheological modifiers, and/or other additives to the drilling fluid until it matches and/or satisfies one or more desired drilling fluid properties. The drilling fluid system (356) may also be configured to acquire mudlogging data by analyzing and characterizing the properties of drilling fluid that has returned to the surface and its entrained gases and cuttings.

In one or more embodiments, the drilling operations system (199) is configured with, or otherwise enabled, for geosteering (354). Geosteering (354) may be used to position the drill bit or drill string of the drilling system relative to a boundary between different subsurface layers (e.g., overlying, underlying, and lateral layers of a pay zone) during drilling operations. In particular, the automated drilling manager (150) may communicate geosteering commands (e.g., command X (370)) to the drilling operations system (110) based on well log data updates (e.g., LWD logs) that are further adjusted by the reservoir simulator (340). As such, the automated drilling manager (150) may generate one or more control signals (e.g., command X (370)) for drilling equipment (or a logging system may generate for logging equipment) based on an updated planned wellbore path (352). As such, geosteering (354) may use various sensors (e.g., sensor suite (358)) located inside or adjacent to the drill string to determine different rock formations within a well path. In some embodiments, geosteering (354) may use resistivity or acoustic measurements to guide the drill bit during horizontal or lateral drilling.

In accordance with one or more embodiments, the gas advanced horizontal well development system (300) includes a gas advanced horizontal well manager (310). The gas advanced horizontal well manager (310), among other things, identifies candidate gas advanced horizontal wells and prescribes a development workflow for said wells based on, at least in part, the subsurface geology including special consideration for the Khuff formation. Generally, long horizontal wells are extremely challenging to drill and complete compared to vertical or deviated wells. To successfully drill and develop a long horizontal well, considerations must be given to, at least: well selection; reservoir characteristics such as pressure; lateral direction design accounting for dipping subsurface geological layers; and the feasibility of hydraulic fracturing. In one or more embodiments, the gas advanced horizontal well manager (310) includes a reservoir criterion (301). The reservoir criterion (301) initially establishes whether a candidate well can be further considered for development as a gas advanced horizontal well. In particular, the reservoir criterion (301) outlines a clear set of conditions that must be met for a candidate well to be developed as a gas advanced horizontal well. The set of conditions are related to reservoir characteristics and wellbore path constraints in view of subsurface geology. That is, the reservoir criterion (301) removes ambiguity relating to the previously described drilling and development challenges associated with long horizontal wells. The reservoir criterion (301) enforces well candidate selection to maximize natural gas production at the lowest investment cost.

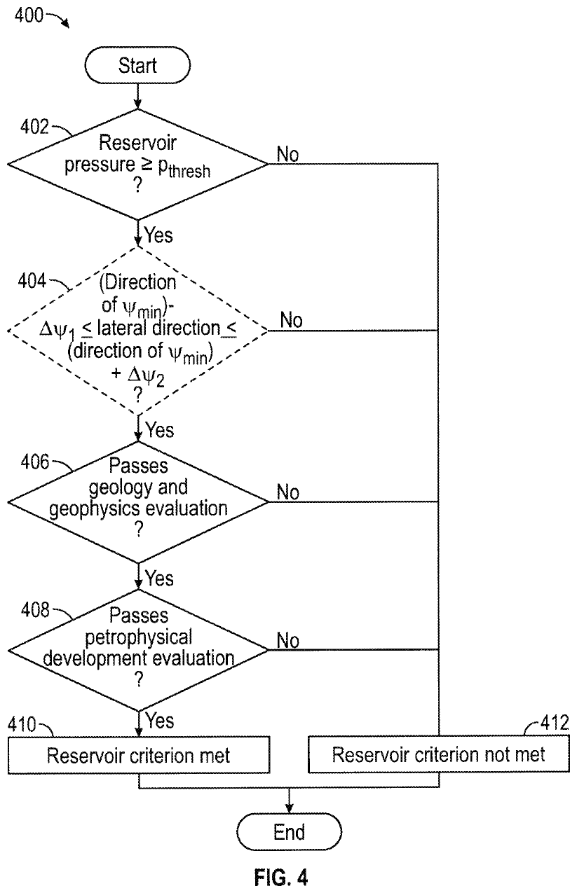

FIG. 4 depicts a reservoir criterion flowchart (400). The reservoir criterion flowchart (400) graphically depicts the set of conditions that all must be met in order to satisfy the reservoir criterion (301). In Block 402, the reservoir pressure is compared to a pressure threshold, Pthresh. If the reservoir pressure is equal to or greater than the pressure threshold then the reservoir criterion flowchart (400) may proceed to Block 404. If the reservoir pressure is strictly less than the pressure threshold, then the reservoir criterion is not met, as is established in Block 412, and the well is no longer considered for development as a gas advanced horizontal well. The reservoir pressure must exceed the pressure threshold to safely deliver the well without incurring financial losses. In accordance with one or more embodiments, the pressure threshold is tailored to reservoirs associated with the Khuff formation. In one or more embodiments, the pressure threshold is 4000 pounds per square inch (psi).

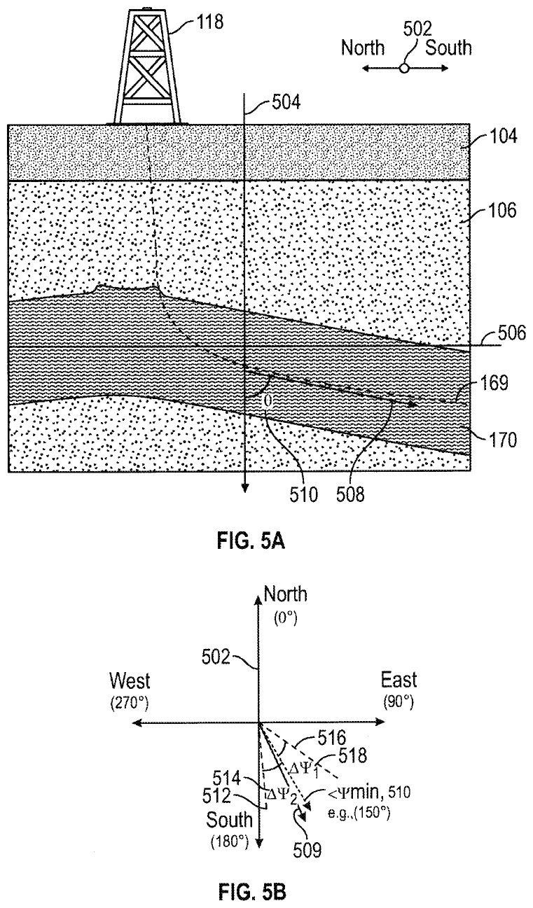

Continuing with FIG. 4, Block 404 checks whether a lateral direction of the wellbore path (or the lateral portion or section of the well) can be drilled within a predefined deviation centered on the minimal stress azimuthal direction, ∠ψₘᵢₙ, of the subsurface (or a subsurface formation to be penetrated). ∠ψₘᵢₙ indicates the “angle” or “degrees” (or radians) of a vector that points in the azimuthal direction of minimum stress, where the angle is given with respect to an arbitrary datum (e.g., cardinal North). The lateral direction and predefined deviation centered on the minimal stress azimuthal direction are illustrated in FIGS. 5A and 5B in accordance with one or more embodiments. In FIG. 4, Block 404 is depicted with a dashed outline. The meaning of the dashed outline will be described in greater detail later in the instant disclosure, however, for now it is sufficient to say that Block 404 may be omitted from the reservoir criterion flowchart (400) if the lateral direction of the wellbore path is checked as part of the well directional plan criterion (302) described below.

FIG. 5A depicts an example well site like that of FIG. 1. In particular FIG. 5A depicts a planned wellbore path (169) that penetrates subsurface formations (104, 106) and alters its trajectory to be non-vertical to proceed through a target zone (170). FIG. 5A further depicts a depth vector (504) that points directly “down” into the subsurface, or is perpendicular to the surface of the Earth without accounting for any local topology (i.e., the depth vector (504) is not perpendicular to any localized “slopes” on the surface of the Earth). In one or more embodiments, the depth vector (504) is used to measure the true vertical depth (TVD) of a well and the measurements regarding the length or distance traversed by a well may be referred to as distance or depth. That is, for a horizontal section of a wellbore, the depth may increase while the true vertical depth remains constant. Herein, the non-vertical trajectory may be referred to as a “horizontal trajectory” or “horizontal” and the term “horizontal,” as used herein, does not require that the trajectory be perpendicular to the depth vector (504). FIG. 5A further depicts a lateral plane (506) that is perpendicular to the depth vector (504).

FIGS. 5A and 5B also depict a compass rose (502) that provides a cardinal orientation to the figures. It is noted that the compass rose (502) may be said to be coplanar with the lateral plane (506). In the present examples, a specific orientation may be specified using degrees relative to the compass rose (502), where the direction of North is set at 0° and the degrees increase in value in a clockwise fashion relative to the North prong of the compass rose (502). The planned wellbore path (169) may be projected onto the lateral plane (506) with the resultant projection described as a lateral direction (509). FIG. 5B depicts the lateral direction (509) relative to the compass rose (502).

FIG. 5B also depicts the minimum stress azimuthal direction at the well location depicted in FIG. 5A determined using, at least in part, a geomechanical stress model. In one or more embodiments, the geomechanical stress model is part of the subsurface model (330). Acquisition of geomechanical data and methods to obtain the the minimum stress azimuthal direction may include, but are not limited to: oriented caliper log; global stress direction map; etc. As stated, Block 404 of FIG. 4 checks whether the lateral direction (509) of the wellbore path (or the lateral portion or section of the well) can be drilled within a predefined deviation centered on the minimal stress azimuthal direction (510), ∠ψₘᵢₙ, of the subsurface (or a subsurface formation to be penetrated). FIG. 5B depicts the minimum stress azimuthal direction (510) relative to the compass rose (502), which, in this example, is 150 degrees.

In accordance with one or more embodiments, the predefined deviation is described using a first deviation (518), Δψ₁, and a second deviation (514), Δψ₂. The first deviation (518) is used to determine a lower bound (516) for an acceptable lateral direction (509). In one or more embodiments, the lower bound (LB) (516) is given as

$$LB = {∠ψ}_{min} - Δ {ψ}_{1} , \qquad ( 2 )$$

where the first deviation (518) has the same angular units as that used to describe the minimum stress azimuthal direction (510). Thus, the lower bound (518) is an angle (degrees or radians) relative to an established datum. Likewise, the second deviation (514) is used to determine an upper bound (512) for an acceptable later direction (509), where the upper bound (UB) (512) is given as

$$UB = ∠ {ψ}_{min} + Δ {ψ}_{2} . \qquad ( 3 )$$

Again, the second deviation (514) has the same angular units as that used to describe the minimum stress azimuthal direction (510). Thus, the upper bound (512) is an angle (degrees or radians) relative to an established datum. Accordingly, in one or more embodiments, Block 404 checks whether the lateral direction (509) is within a range prescribed by the lower bound (516) and upper bound (512) (i.e., [LB, UB]). Mathematically, this may be written as

$$LB \leq lateral direction \leq UB , or \qquad ( 4 )$$

$$( {∠ψ}_{min} - Δ {ψ}_{1} ) \leq lateral direction \leq ( {∠ψ}_{min} + {Δψ}_{2} ) .$$

In one or more embodiments, the first deviation (518) and second deviation (514) are set to the same value such that the predefined deviation is truly centered about the minimum stress azimuthal direction (510). However, in general, the predefined deviation, when viewed as a range of acceptable angles or directions need only contain the minimum stress azimuthal direction (510). In one or more embodiments, the first deviation (518) and the second deviation (514) are each set to 25 degrees. One with ordinary skill in the art will recognize that an angular datum (such as the compass rose) can be set up using a cyclical, or “wrapped,” angular metric (e.g., degrees always specified between the values of 0 and 359 and 360 degrees is mapped to 0 degrees, etc.) or using an absolute angular metric (e.g., negative degrees allowed and degrees exceeding the value of 359 are allowed). In the latter case, it is possible for the upper bound (512) to have a value that is less than the upper bound (516). However, one with ordinary skill in the art will appreciate that such an angular datum and angular metric may be properly employed to describe a predefined deviation without ambiguity.

In summary, in Block 404, the lateral direction (509) is compared to a predefined deviation based on the minimum stress azimuthal direction (510). In accordance with one or more embodiments, the predefined deviation specifies a range of acceptable values (or directions) for the lateral direction (509). If the lateral direction (509) is within the range specified by the predefined deviation, then the reservoir criterion flowchart (400) may proceed to Block 406. If the lateral direction (509) is outside the range specified by the predefined deviation then the reservoir criterion is not met, as is established in Block 412, and the well is no longer considered for development as a gas advanced horizontal well. This comparison ensures that gas advanced horizontal wells are drilled in an efficient manner.

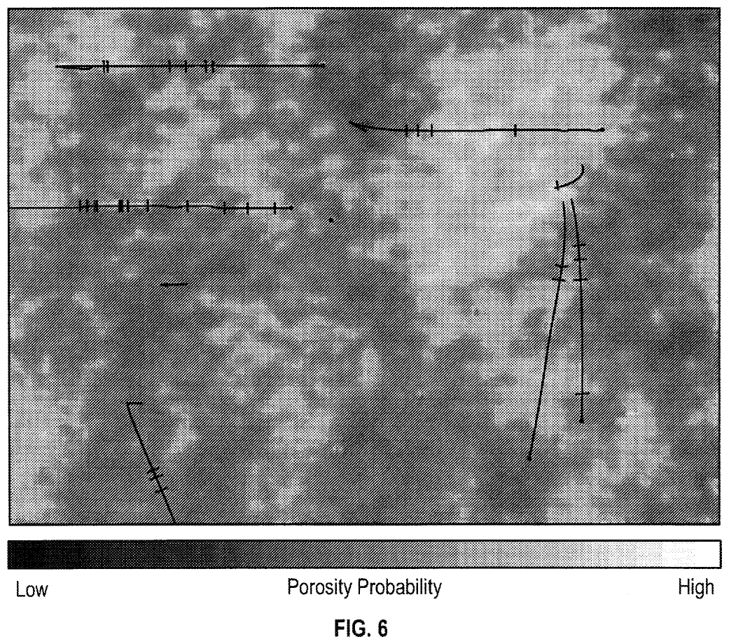

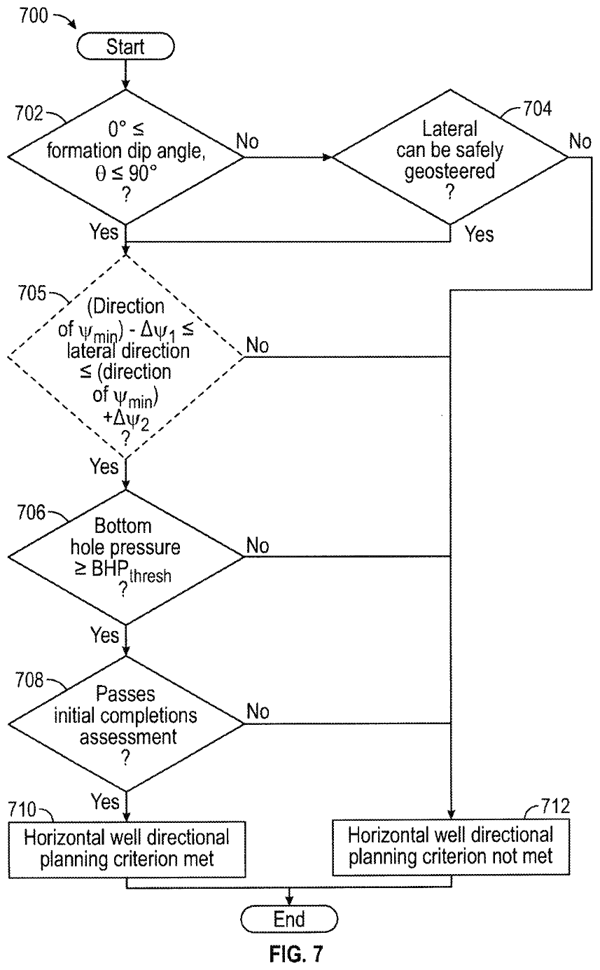

Keeping with FIG. 4, in Block 406 it is determined if the candidate well passes a geology and geophysics evaluation. In accordance with one or more embodiments, the geology and geophysics evaluation includes determining a porosity estimate for a reservoir to be penetrated by the candidate well. Reservoir porosity may be estimated using any tool known in the art, such as a seismic impedance survey. In accordance with one or more embodiments, seismic data (322) may be stored in an external database (320) accessible by the gas advanced horizontal well manager (310) and used to determine a porosity estimate. In one or more embodiments, the subsurface model (330) includes a porosity model. FIG. 6 depicts a porosity “heat map” corresponding to a cross-sectional area of a subsurface. The porosity heat map identifies regions of relatively high or low porosity. In one or more embodiments, the subsurface model (330) includes a porosity model where the porosity model may be visualized as a porosity heat map. In one or more embodiments, a porosity estimate is determined by integrating an area, volume, or line (e.g. path integral) encompassing a planned or proposed wellbore path over (or through) a porosity model of the subsurface. In such a case, the porosity model is used to obtain either an accumulated or average porosity over the area, volume, or line. In other embodiments, the porosity estimate is defined as the minimum porosity value over (or through) a given area, volume, or line that encompasses a planned or proposed wellbore path (e.g., well lateral). In other embodiments still, the porosity estimate is a measure of the average porosity of the reservoir to be penetrated by the candidate well. In accordance with one or more embodiments, the geology and geophysics evaluation further determines a formation dip angle (see FIG. 7 and accompanying discussion). As will be described later in the instant disclosure, to consider a well for development as a gas advanced horizontal well, the formation dip angle must be “downward” dipping. Thus, in one more embodiments, the geology and geophysics evaluation may also be said to encompass, or at least relate to, a formation dip angle evaluation.

In one or more embodiments, the geology and geophysics evaluation is performed by comparing the porosity estimate to a porosity threshold. If the porosity estimate is greater than the porosity threshold, then the candidate well may be said to pass the geology and geophysics evaluation. In one or more embodiments, the porosity estimate is determined as the average porosity of a volume surrounding a section of a planned wellbore path (e.g., a lateral section) and the porosity threshold is set to 15%. As stated, in some embodiments, passing of the geology and geophysics evaluation may further require passing a formation dip angle requirement, where the formation dip angle is determined as part of the geology and geophysics evaluation.

If geology and geophysics evaluation is passed then the reservoir criterion flowchart (400) may proceed to Block 408. If the geology and geophysics evaluation is not passed, then the reservoir criterion is not met, as is established in Block 412, and the well is no longer considered for development as a gas advanced horizontal well.

In Block 408, it is determined if the candidate well passes a petrophysical development evaluation. In accordance with one or more embodiments, the geology and geophysics evaluation includes determining an offset well porosity estimate for a candidate well. In one or more embodiments, the offset well porosity estimate is determined using offset data (326) stored in the external database (326). The offset data (326) includes measured porosity values local to one or more previously drilled wells. In general, a previously drilled well must be within a distance threshold from the candidate well to be considered an offset well. In one or more embodiments, the distance threshold is 10 kilometers measured as a Euclidean distance (i.e., radius) from the candidate well.

In one or more embodiments, the petrophysical development evaluation is performed by comparing the offset well porosity estimate to an offset porosity threshold. If the offset well porosity estimate is greater than the offset porosity threshold, then the candidate well may be said to pass the petrophysical development evaluation. If the petrophysical development evaluation is passed then the reservoir criterion is considered met, as is established in Block 410.

Thus, in one or more embodiments, the reservoir criterion flowchart (400) of FIG. 4 is used to determine if the reservoir criterion (301) is satisfied. If, for a given candidate well, the reservoir criterion (301) is satisfied, then the gas advanced horizontal well manager (310) may further consider the candidate well for development as a gas advanced horizontal well. In one or more embodiments, the gas advanced horizontal well manager (310) further includes a well directional plan criterion (302).

The well directional plan criterion (302) is directed toward drilling challenges. Specifically, the well direction plan criterion (302) determines if a candidate well, after meeting the reservoir criterion (301), can be developed with reduced risk of drilling assembly stall in the wellbore. The well directional plan criterion (302) outlines a clear set of conditions that must be met for a candidate well to be developed as a gas advanced horizontal well.

FIG. 7 depicts a well directional plan criterion flowchart (700). The well directional plan criterion flowchart (700) graphically depicts the conditions and resultant outcomes that lead to either the satisfying (Block 710) or not meeting (Block 712) the well directional plan criterion (302). In Block 702, a formation dip angle is checked relative to the depth vector (504) to ensure that the subsurface formation traversed by the lateral portion of the candidate well, according to a planned wellbore path, has a down dip angle. Returning to FIG. 5A, FIG. 5A depicts a dip vector (508) that represents, at least generally, the “dip” or angel of a subsurface formation with respect to the lateral plane (506) (or, in some instances, with respect to the surface of the Earth). In accordance with one or more embodiments, the dip angle is determined using a dip model of the subterranean region of interest. In one or more embodiments, the dip model is included in the subsurface model (330).

In one or more embodiments, the dip vector is only considered for section(s) of the wellbore that traverse a target zone (170) of the subsurface and/or are considered to be lateral sections. In one or more embodiments, the dip vector (508) is determined as a vector that is tangential to a line segment with termination points at the beginning and end of the planned wellbore path (169) over the portion of the planned wellbore path that traverses the formation of interest (i.e., the subsurface formation to which the formation dip angle applies). That is, when the dip vector (508) is based on a planned wellbore path (169) that traverses a subsurface formation of interest (e.g., target zone (170)), the dip vector (508) need not be tangential to every point along the planned wellbore path (169). In this case, the planned wellbore path is determined using, at least in part, the dip model of the subterranean region of interest.

Herein, the formation dip angle (510) is specified as the angle between the depth vector (504) and the dip vector (508) depicted as θ in FIG. 5A. As seen, in Block 702, if the dip angle (510) is between 0 and 90 degrees, inclusive, then the subsurface formation where the dip angle (510) is determined is said to be a downward dipping formation and the flowchart of FIG. 7 proceeds to Block 705. If, however, the dip angle (510) is not between 0 and 90 degrees, inclusive, relative to the depth vector, then the subsurface formation where the dip angle (510) is determined is said to be an upward dipping formation and the flowchart of FIG. 7 proceeds to Block 704. In general, the well direction plan criterion (302) allows for further consideration of a candidate well as a gas advanced horizontal well if the result Block 702 is a “yes.” That is, a candidate well with a downward dipping formation is not discounted from consideration as a gas advanced horizontal well. Likewise, a candidate well with an upward dipping formation is not discounted from consideration as a gas advanced horizontal well but must be further evaluated with a geosteering step in Block 704.

Geosteering (354), as previously discussed, consists of positioning and guiding a drill bit or drill string of a drilling system relative to a boundary between different subsurface layers (e.g., overlying, underlying, and lateral layers of a pay zone) during drilling operations. In Block 704, it is determined whether the horizontal or lateral portion of a candidate well can still be geosteered safely along a planned wellbore path after taking into account the anticipated variations in formation dip angle (510). This determination is made by subject matter experts after analyzing expected drilling parameters, offset data (326) (e.g., drilling history of offset wells), and in view of the dip model (i.e., subsurface model (330)). If it is determined that a planned wellbore path (169) cannot be safely geosteeered, or geosteered with a high degree of confidence, then it is said that a horizontal well directional planning criterion is not met, as established in Block 712. If, however, it is determined that a planned wellbore path (169) can be safely navigated with geosteering (354), then the well directional plan criterion flowchart (700) of FIG. 7 proceeds to Block 705.

Block 705 is depicted in FIG. 7 using a dashed outline. This is because Block 705 is identical to Block 404 of the reservoir criterion flowchart (400). That is, Block 705 checks whether the lateral direction (509) of the wellbore path (or the lateral portion or section of the well) can be drilled within a predefined deviation centered on the minimal stress azimuthal direction (510), ∠ψₘᵢₙ, of the subsurface (or a subsurface formation to be penetrated). Block 705 is depicted using a dashed outline because this block need not be repeated if already passed in the reservoir criterion flowchart (400). However, in one or more embodiments, the lateral direction is checked against the predefined deviation from the minimal stress azimuthal direction (510) in Block 705 of the well directional plan criterion flowchart (700) instead of during Block 404 of the reservoir criterion flowchart (400). That is, the check of the lateral direction (509) can occur as part of either the reservoir criterion (301) or the well directional plan criterion (302). Technically, the check of the lateral direction (509) can occur in both the reservoir criterion (301) and the well directional plan criterion (302) but would be redundant.

If Block 705 is not evaluated, because the lateral direction (509) was previously checked as part of the reservoir criterion (301), then the well directional plan criterion flowchart (700) proceeds to Block 706. If Block 705 is evaluated and the lateral direction (509) is within the range specified by the predefined deviation, then the well directional plan criterion flowchart (700) may proceed to Block 706. If, however, Block 705 is evaluated and the lateral direction (509) is outside the range specified by the predefined deviation then the horizontal well directional planning criterion is not met, as is established in Block 712, and the well is no longer considered for development as a gas advanced horizontal well.

In Block 706, the bottom hole pressure is compared to a bottom hole pressure threshold, BHPthresh. If the bottom hole pressure is equal to or greater than the bottom hole pressure threshold then the well development plan criterion flowchart (700) may proceed to Block 708. If the bottom hole pressure is strictly less than the bottom hole pressure threshold, then the horizontal well directional planning criterion is not met, as is established in Block 712, and the well is no longer considered for development as a gas advanced horizontal well. The bottom hole pressure check of Block 706 is performed to ensure that there is enough pressure to create transverse fractures, because fracturing is deemed the most effective method for gas production for reservoirs having passed the geology and geophysics evaluation of Block 406 in the previously applied reservoir criterion flowchart (400). A transverse fracture is an induced hydraulic fracture orientated orthogonally to the wellbore path to extend the “contact” of the well into the reservoir. In one or more embodiments, the feasibility of creating transverse fractures is also evaluated using a reservoir simulator (340). As such, in these embodiments, the decision of Block 706 may further rely on the results of a simulation regarding transverse fracturing in addition to the comparison of the bottom hole pressure to the bottom hole pressure threshold. In one or more embodiments, the bottom hole pressure threshold is 15,000 pounds per square inch (psi).

In Block 708, it is determined if the candidate well passes an initial completions assessment. A candidate well cannot be considered for development as a gas advanced horizontal well if, despite meeting the reservoir criterion (301) and the aforementioned conditions of the well directional plan criterion (302), which generally suggest that a gas advanced horizontal well can be successfully drilled with a high expectation of optimal production, if the well cannot be properly completed with multistage stimulation (i.e., undergo multistage completions). In accordance with one or more embodiments, initial completions assessment includes a check that completions equipment for the candidate well can be run to the target depth. In one or more embodiments, the determination whether the candidate well can be completed to the target depth is based on, at least in part, a torque and drag simulation of well completion along the planned horizontal wellbore path. Further decisions regarding the type and/or method of completions is described by the completions rule set (304) of the gas advanced horizontal well manager (310) discussed later in the instant disclosure. If the initial completions assessment is passed then the horizontal well directional planning criterion is considered met, as is established in Block 710. Otherwise, the horizontal well directional planning criterion is not met, as established in Block 712.

In accordance with one or more embodiments, the reservoir criterion (301) and the well directional plan criterion (302) must each be met for a candidate well to be considered for development as a gas advanced horizontal well. Once a candidate well has been identified as a gas advanced horizontal well, then the petrophysical logging tools rule set (303) and the completions rule set (304) of the gas advanced horizontal well manager (310) may be applied to dictate aspects of the drilling process and completions process of the gas advanced horizontal well.

In accordance with one or more embodiments, the petrophysical logging tools rule set (303) prescribes the tools and petrophysical logging requirements when drilling a gas advanced horizontal well. In general, there are a variety of logs that can be acquired while drilling a well and each log may be obtained using one or more tools and/or methods. As such, the petrophysical logging tools ruleset (303) of the gas advanced horizontal well manager (310) removes the ambiguity as to which tools and/or methods should be applied when drilling a gas advanced horizontal well in a subsurface associated with Khuff formation. In accordance with one or more embodiments, the petrophysical logging tools ruleset (303) is shown in Table I.

TABLE I
Example embodiment of Petrophysical Logging Tools Rule Set

| Petrophysical Log(s) | Tool/Method |
|---|---|
| Gamma Ray; | Logging While Drilling |
| Resistivity; | (LWD) |
| Density; | |
| Neutron | |
| Drilled Wellbore Diameter | Tubular Conveyed Logging |
| (Pre-Khuff) | (TLC) |
| Drilled Wellbore Diameter | Artificial Intelligence (AI) |
| (Khuff) | Caliper Model |
| Sonic | Artificial Intelligence (AI) |
| | Sonic Model |
| Mudlogging | Full Mudlogging Suite |

As seen in Table I, in accordance with one or more embodiments, the petrophysical logging tools rule set (303) prescribes that the petrophysical logs of gamma ray (GR), resistivity, density, and neutron should be acquired when drilling a gas advanced horizontal well using a logging while drilling (LWD) tool. This set of real time data is used to geosteer the horizontal well most effectively in the target zone. Further, a measurement or estimate of the drilled wellbore diameter should be obtained. The petrophysical and logging tools rule set (303) prescribes two different methods of obtaining the drilled wellbore diameter, where a single method is selected based on the disposition of the well with respect to the Khuff formation. If the well is drilled such that it is above the Khuff formation (i.e., pre-Khuff), then a mechanical caliper is used to determine the drilled wellbore diameter. In particular, the drilled wellbore diameter is measured using tubular conveyed logging (TLC). If the well penetrates the Khuff formation (i.e., Khuff), then an estimate of the drilled wellbore diameter is obtained using an artificial intelligence (AI) caliper model tailored to the Khuff formation based on the logs obtained for the LWD tool. The petrophysical and logging tools rule set (303) further prescribes that a sonic log is acquired using an artificial intelligence (AI) sonic model trained from offset well data. Similar to the AI caliper model, the AI sonic model predicts the sonic log given, at least, the other petrophysical logs obtained using the LWD tool. Additionally, the AI sonic model provides minimum stress values throughout the horizontal well path with stress values typically ranging between 0.5 to 1.25 psi/ft. Because the petrophysical and logging tools rule set (303) prescribes the use of at least one AI-based model, the gas advanced horizontal well manager (310) may further be said to include AI models (305). In general, AI models (305) may be considered functions that receive an input, for example, LWD data, and produce an output (e.g., caliper log or wellbore diameter, sonic log, etc.). Typically, AI models (305) are not formed using any physical considerations but have their functional relationship between the inputs and outputs determined using previously acquired data composed of input-output pairs. Finally, the petrophysical logging tools rule set (303) prescribes that a full mudlogging suite be used to acquire mudlogging data. Mudlogging data may include an analysis and lithology determination of the drill cuttings entrained in the mud returning from the wellbore as well as a characterization of subsurface gases entrained in the returning mud (e.g., gas volume measurement, concentration measurement of at least one constituent gas).

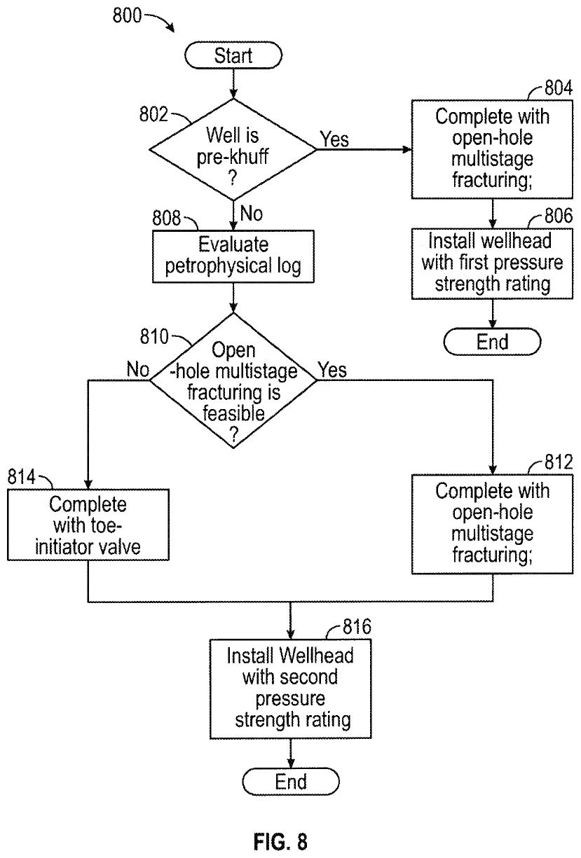

In accordance with one or more embodiments, the completions rule set (304) prescribes, at least partially, the methods and procedures that should be taken to complete the gas advanced horizontal based on, at least, the location of the well relative to the Khuff formation. FIG. 8 depicts the completions rule set (304) as a completions flowchart (800). In Block 802, the gas advanced horizontal well is distinguished by its position relative to the Khuff formation. If the gas advanced horizontal well does not penetrate the Khuff formation (i.e., is pre-Khuff), the gas advanced horizontal well is completed using open-hole multistage fracturing as depicted in Block 806. Further, a wellhead with a first pressure strength rating is installed on the gas advanced horizontal well. In one or more embodiments, the first pressure strength rating is 15,000 pounds per square inch (psi). If the gas advanced horizontal well penetrates the Khuff formation (i.e., is not pre-Khuff), then the completions flowchart (800) of FIG. 8 proceeds to Block 808. In Block 808, the petrophysical log, acquired according to the petrophysical logging tools rule set (303), is evaluated. The petrophysical log is evaluated in order to determine if the gas advanced horizontal well can be completed using open-hole multistage fracturing. In this case, the petrophysical log obtained from logging while drilling (LWD) is evaluated for porosity development information along the horizontal lateral drilled. In general, porosity development can be either continuous or intermittent along the well path. As such, open-hole multistage fracturing can be applied in a well penetrating the Khuff formation to target intermittent porosity packages along the horizontal well path. In one or more embodiments, this determination is made by a subject matter expert in view of the porosity development information. Thus, if the gas advanced horizontal well is pre-Khuff (Block 802), then it is completed with open-hole multistage fracturing, however, if the gas advanced horizontal well penetrates the Khuff formation then open-hole multistage fracturing is only applied if determined appropriate by the subject matter expert based on the petrophysical log (e.g., porosity development information from LWD). Block 810 indicates that if the subject matter expert determines that open-hole multistage fracturing is appropriate, then the gas advanced horizontal well is completed with open-hole multistage fracturing in Block 812. However, if open-hole multistage fracturing is not determined to be appropriate for the Khuff-penetrating well, then, in Block 814, the gas advanced horizontal well is completed with a toe-initiator valve (TIV). In one or more embodiments, the TIV is set to operate at a pressure withing the range of 6,000 to 11,000 psi differential pressure based on the specific well condition. Finally, for Khuff-penetrating wells, in Block 816 a wellhead with a second pressure strength rating is installed on the gas advanced horizontal well. In one or more embodiments, the first pressure strength rating is greater than the second pressure strength rating. In one or more embodiments, the second pressure strength rating is 10,000 pounds per square inch (psi).

In summary, the gas advanced horizontal well manager (310), among other things, identifies candidate gas advanced horizontal wells and prescribes a development workflow for said wells based on, at least in part, the subsurface geology including special consideration for the Khuff formation. In particular, the gas advanced horizontal well manager (310) determines that a candidate well may be developed as a gas advanced horizontal well if the reservoir criterion (301) and the well directional plan criterion (302) are met according to the reservoir criterion flowchart (300) and well direction plan criterion flowchart (700), respectively. Once a potential gas advanced horizontal well has been identified, the gas advanced horizontal well manager (310) further prescribes, at least some, of the steps, processes, procedures, and tools that should be employed and/or applied to develop the gas advanced horizontal well. As such, gas advanced horizontal wells can be developed with minimal risk, with reduced development costs, and efficient production. In practice, when gas advanced horizontal wells are identified and developed according to the gas advanced horizontal well manager (310), fewer new wells are required to be drilled to maintain or achieve production targets. The use of fewer wells to maintain or achieve production targets makes for a more efficient oil and gas field and results in substantial economic savings.

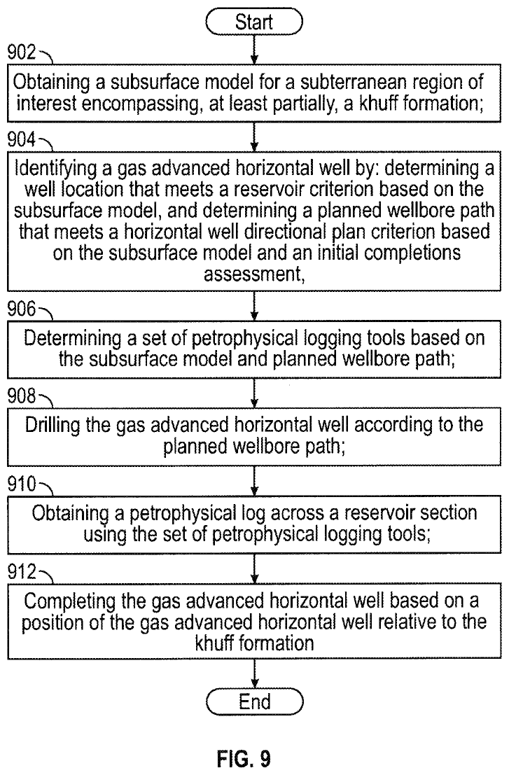

FIG. 9 depicts a flowchart in accordance with one or more embodiments. In Block 902, a subsurface model (330) for a subterranean region of interest is obtained. In accordance with one or more embodiments, the subterranean region of interest encompasses, at least partially, the Khuff formation. The subsurface model (330) is a digital representation of one or more properties of the subterranean region of interest. For example, the subsurface model (330) may include porosity data for the subterranean region of interest. In Block 904, a gas advanced horizontal well is identified. The identification of a gas advanced horizontal well includes, at least, two parts. First, a candidate well, or potential gas advanced horizontal well, is evaluated using a reservoir criterion (301) where the reservoir criterion makes use of the subsurface model (330). If the reservoir criterion (301) is not met, then the candidate well is not considered for development as a gas advanced horizontal well. Second, the candidate will is evaluated using a well directional plan criterion (302), where the well direction plan criterion (302) makes use of the subsurface model (330) and includes an initial completions assessment. Again, if the well directional plan criterion (302) is not met, then the candidate well is not considered for development as a gas advanced horizontal well. Thus, in Block 904, a candidate well is identified as a gas advanced horizontal well if the candidate well meets both the reservoir criterion (301) and the well directional plan criterion (302). Once the gas advanced horizontal well has been identified, it may be developed according to the petrophysical logging tools rule set (303) and the completions rule set (304). Continuing with FIG. 9, in Block 906, a set of petrophysical logging tools is determined. In accordance with one or more embodiments, the set of petrophysical logging tools is determined based on the petrophysical logging tools rule set (303), where the petrophysical logging tools rule set (303) specifies which logging tools should be employed when drilling the gas advanced horizontal well. Notably, the petrophysical logging tools rule set (303) is based on the subsurface model (330) and planned wellbore path (i.e., the location of the wellbore relative to the Khuff formation). That is, the petrophysical logging tools rule set (303) identifies different sets of petrophysical logging tools (or logs to be obtained) based on, at least, the disposition of the planned wellbore relative to the Khuff formation (i.e., pre-Khuff or Khuff-penetrating). In Block 908, the gas advanced horizontal well is drilled according to the planned wellbore path. Further, in Block 910, while drilling the gas advanced horizontal well, logs are collected across a reservoir section traversed by the wellbore using the set of petrophysical logging tools previously determined. Finally, in Block 912, after drilling the gas advanced horizontal well, the gas advanced horizontal well is completed according to a completions plan, where the completions plan is specified, at least in part, by the completions rule set (304). In one or more embodiments, the completions rule set (304) specifies different completions procedures dependent on the position of the gas advanced horizontal well relative to the Khuff formation (i.e, pre-Khuff or Khuff-penetrating). As such, the flowchart of FIG. 9 may be applied to identify and develop a gas advanced horizontal well in accordance with one or more embodiments.

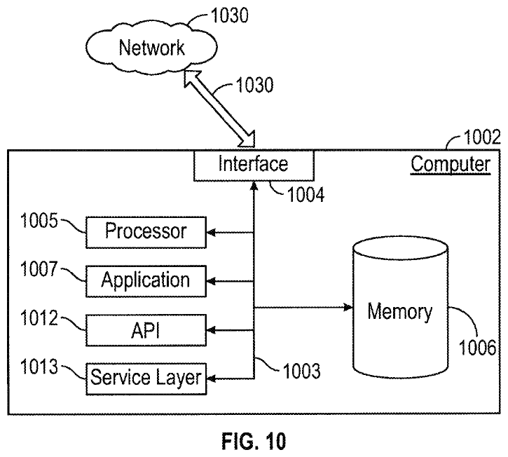

FIG. 10 depicts a block diagram of a computer system (1002) used to provide computational functionalities associated with described algorithms, methods, functions, processes, flows, and procedures as described in this disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). The memory may be a non-transitory computer readable medium. For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a subsurface model for a subterranean region of interest encompassing, at least partially, a Khuff formation;
identifying a gas advanced horizontal well by:
determining a well location that meets a reservoir criterion based on the subsurface model, and
determining a planned wellbore path that meets a horizontal well directional plan criterion based on the subsurface model and an initial completions assessment,
determining a set of petrophysical logging tools based on the subsurface model and planned wellbore path;
drilling the gas advanced horizontal well according to the planned wellbore path;
obtaining a petrophysical log across a reservoir section using the set of petrophysical logging tools; and
completing the gas advanced horizontal well based on a position of the gas advanced horizontal well relative to the Khuff formation.

2. The method of claim 1, wherein the subsurface model comprises:
a pressure of a reservoir,
a dip model of the subterranean region of interest;
a geomechanical stress model;
a porosity model; and
offset well data.

3. The method of claim 2, wherein determining a well location that meets a reservoir criterion comprises:
determining that the pressure of the reservoir is greater than a pressure threshold;
determining that a lateral direction of the gas advanced horizontal well has a direction that is within a predefined deviation from a minimum stress azimuthal direction, where the minimum stress azimuthal direction is determined using, at least in part, the geomechancial stress model;
determining that a porosity estimate is greater than a porosity threshold, wherein the porosity estimate is based on the porosity model and offset well data.

4. The method of claim 3, wherein determining a planned wellbore path that meets a horizontal well directional plan criterion comprises:
determining that a dip angle is greater than or equal to 0 degrees and less than or equal to 90 degrees relative to a depth vector, wherein the dip angle is determined using the dip model of the subterranean region of interest, and, if not, determining whether a horizontal lateral can be geosteered;
determining that a bottom hole pressure is greater than a bottom hole pressure threshold; and
determining that a well completion can be run to a total depth of the gas advanced horizontal well.

5. The method of claim 1, wherein determining a set of petrophysical logging tools comprises:
using a tubular logging conveyed mechanical caliper to determine a drilled wellbore diameter if the gas advanced horizontal well is above the Khuff formation, and otherwise using an artificial intelligence caliper model to estimate the drilled wellbore diameter.

6. The method of claim 1, wherein completing the gas advanced horizontal well based on a position of the gas advanced horizontal well relative to the Khuff formation comprises:
if the gas advanced horizontal well is above the Khuff formation:
completing the gas advanced horizontal well using open-hole multistage fracturing, and
installing a wellhead with a first pressure strength rating;
if the gas advanced horizontal well penetrates the Khuff formation:
determining if the gas advanced horizontal well can be completed using open-hole multistage fracturing based on the petrophysical log and, if so, completing the gas advanced horizontal well using open-hole multistage fracturing, otherwise, completing the gas advanced horizontal well with a toe-initiator valve, and
installing a wellhead with a second pressure strength rating;
wherein the first pressure strength rating is greater than the second pressure strength rating.

7. The method of claim 6, wherein the first pressure strength rating is 15,000 pounds per square inch and the second pressure strength rating is 10,000 pounds per square inch.

8. A system, comprising:
a drilling operations system configured to drill a wellbore through a subterranean region of interest encompassing, at least partially, a Khuff formation;
a computer configured to:
obtain a subsurface model for the subterranean region of interest;
identify a gas advanced horizontal well by:
determining a well location that meets a reservoir criterion based on the subsurface model, and
determining a planned wellbore path that meets a horizontal well directional plan criterion based on the subsurface model and an initial completions assessment,
determine a set of petrophysical logging tools based on the subsurface model and planned wellbore path;
transmit a command signal to the drilling operations system to drill the gas advanced horizontal well according to the planned wellbore path;
obtain a petrophysical log across a reservoir section using the set of petrophysical logging tools; and
determine a completions plan for the gas advanced horizontal well based on a position of the gas advanced horizontal well relative to the Khuff formation.

9. The system of claim 8, wherein the drilling operations system comprises:
a drilling fluid system configured to condition drilling fluid before entering the wellbore and to obtain mudlogging data based on the drilling fluid surfacing from the wellbore.

10. The system of claim 9, wherein the petrophysical log comprises mudlogging data.

11. The system of claim 8, wherein the subsurface model comprises:
a pressure of a reservoir,
a dip model of the subterranean region of interest;
a geomechanical stress model;
a porosity model; and
offset well data.

12. The system of claim 11, wherein determining a well location that meets a reservoir criterion comprises:
determining that the pressure of the reservoir is greater than a pressure threshold;
determining that a lateral direction of the gas advanced horizontal well has a direction that is within a predefined deviation from a minimum stress azimuthal direction, where the minimum stress azimuthal direction is determined using, at least in part, the geomechancial stress model;
determining that a porosity estimate is greater than a porosity threshold, wherein the porosity estimate is based on the porosity model and offset well data.

13. The system of claim 11, wherein determining a planned wellbore path that meets a horizontal well directional plan criterion comprises:
determining that a dip angle is greater than or equal to 0 degrees and less than or equal to 90 degrees relative to a depth vector, wherein the dip angle is determined using the dip model of the subterranean region of interest, and, if not, determining whether a horizontal lateral can be geosteered;
determining that a bottom hole pressure is greater than a bottom hole pressure threshold; and
determining that a well completion can be run to a total depth of the gas advanced horizontal well.

14. The system of claim 8, wherein the completion plan comprises:
a first specification indicating whether the advanced gas horizontal well should be completed using open-hole multistage fracturing or a toe-initiator valve, and
a second specification indicating a pressure strength rating of a wellhead to be installed on the gas advanced horizontal well,
wherein the first specification and second specification are based on the disposition of the gas advanced horizontal well relative to the Khuff formation.

15. The system of claim 8, wherein the pressure strength rating is 15,000 pounds per square inch if the gas advanced horizontal well is above the Khuff formation and 10,000 pounds per square inch otherwise.

16. A non-transitory computer-readable memory comprising computer-executable instructions stored thereon that, when executed on a processor, cause the processor to perform steps comprising:
obtaining a subsurface model for a subterranean region of interest encompassing, at least partially, a Khuff formation;
identifying a gas advanced horizontal well by:
determining a well location that meets a reservoir criterion based on the subsurface model, and
determining a planned wellbore path that meets a horizontal well directional plan criterion based on the subsurface model and an initial completions assessment,
determining a set of petrophysical logging tools based on the subsurface model and planned wellbore path;
determining a completions plan for the gas advanced horizontal well based on a position of the gas advanced horizontal well relative to the Khuff formation; and
transmitting a command signal to a drilling system to drill the gas advanced horizontal well according to the planned wellbore path.

17. The non-transitory computer-readable memory of claim 16, wherein the subsurface model comprises:
a pressure of a reservoir,
a dip model of the subterranean region of interest;
a geomechanical stress model;
a porosity model; and
offset well data.

18. The non-transitory computer-readable memory of claim 17, wherein determining a well location that meets a reservoir criterion comprises:
determining that the pressure of the reservoir is greater than a pressure threshold;
determining that a lateral direction of the gas advanced horizontal well has a direction that is within a predefined deviation from a minimum stress azimuthal direction, where the minimum stress azimuthal direction is determined using, at least in part, the geomechancial stress model;
determining that a porosity estimate is greater than a porosity threshold, wherein the porosity estimate is based on the porosity model and offset well data.

19. The non-transitory computer-readable memory of claim 17, wherein determining a planned wellbore path that meets a horizontal well directional plan criterion comprises:
determining that a dip angle is greater than or equal to 0 degrees and less than or equal to 90 degrees relative to a depth vector, wherein the dip angle is determined using the dip model of the subterranean region of interest, and, if not, determining whether a horizontal lateral can be geosteered;
determining that a bottom hole pressure is greater than a bottom hole pressure threshold; and
determining that a well completion can be run to a total depth of the gas advanced horizontal well.

20. The non-transitory computer-readable memory of claim 16, wherein determining a set of petrophysical logging tools comprises:
using a tubular logging conveyed mechanical caliper to determine a drilled wellbore diameter if the gas advanced horizontal well is above the Khuff formation, and otherwise using an artificial intelligence caliper model to estimate the drilled wellbore diameter.
